(19) United States
(12) Patent Application Publication
(10) Pub. No.: US 2009/0152188 A1
(43) Pub. Date: Jun. 18, 2009

(54) Liquid filter arrangements; components; and, methods

(75) Inventor: John Hacker, Edina, MN (US)

Correspondence Address: MERCHANT & GOULD PC, P.O. BOX 2903, MINNEAPOLIS, MN, 55402-0903, US

(73) Assignee: DONALDSON COMPANY, INC, Minneapolis, MN (US)

(21) Appl. No.: 12/286,803

(22) Filed: Oct. 1, 2008

Related U.S. Application Data
(60) Provisional application No. 60/997,249, filed on Oct. 2, 2007.

(51) Int. Cl. B01D 35/30

(52) U.S. Cl. 210/233; 210/232

(57) ABSTRACT

Liquid filter assemblies and components therefor are described. A liquid filter is described which includes media extending between first and second end caps; the first and second end caps being configured for advantageous engagement with other components of the liquid filter assembly during use. A liquid filter arrangement, comprising a filter cartridge installed in the housing or bowl is described. Such an arrangement is appropriate for installation on a filter head, to obtain liquid filter operation.

### CROSS-REFERENCE TO RELATED APPLICATIONS

The present application includes the disclosure of U.S. Provisional Application Ser. No. 60/997,249, filed Oct. 2, 2007; the complete disclosure of U.S. 60/997,249 being incorporated herein by reference.

A claim of priority is made to U.S. Provisional Application Ser. No. 60/997,249; to the extent appropriate.

### FIELD OF DISCLOSURE

The present disclosure relates to liquid filter arrangements usable, for example, to filter hydraulic fluids and lubricating fluids. A bowl/cartridge liquid filter assembly, and a removable and replaceable filter cartridge useable therewith, are described. Methods of assembly use are also provided.

### BACKGROUND

Circulating liquid systems such as hydraulic fluid systems and lubricating fluid systems typically require a filter arrangement. The filter arrangement is typically positioned so that the fluids are filtered upon passage through filter media positioned within the filter arrangement. Typically, the filter arrangement is configured so the componentry containing the media is a service part, i.e., so that the media can, periodically, be removed and be replaced.

There are two common types of liquid filter arrangements. A first, typically referred to herein as a “spin on” type, involves a filter head installed on equipment, with a spin on filter member cartridge. The filter member cartridge is often referred to as “spin on” because the assembly including the filter media is typically secured to the filter head by threading. Also, in “spin on” arrangements, the filter media is typically non-removably secured within a shell or a housing as a housing/media combination.

The entire housing/media combination is the filter media member cartridge, and is removed and replaced during servicing.

The second common type of liquid filter arrangement is referred to herein as a bowl/cartridge arrangement. With a bowl/cartridge arrangement, a filter head is again is installed on the equipment. The filter media, however, is contained within a filter cartridge in a form removably positioned within a bowl or shell, i.e. a housing. The housing/cartridge (or bowl/cartridge) combination is removably mounted on a filter head for use. However, during servicing: the housing or bowl is disconnected from the filter head; the media contained within the housing shell or bowl is replaced; and, the same housing, shell or bowl, with replacement media inside, is then remounted on the filter head.

### SUMMARY

According to the present disclosure, a liquid filter assembly and components therefor are described. The liquid filter assembly generally includes a liquid filter head having thereon a removably mounted liquid filter arrangement comprising a bowl or housing with a removable and replaceable liquid filter cartridge installed therein. The liquid filter cartridge generally comprises media extending between first and second end caps configured for preferred interaction with liquid filter head and the bowl.

In a typical arrangement, the liquid filter bowl includes, installed therein, a filter support core. The filter support core can include a seal support thereon, adjacent a closed end of the bowl. The seal support will typically be configured to axially overlap an end of the media pack, when the cartridge is installed. The bowl can include a plurality of ribs therein, for radially interfering engagement with a structure on a filter cartridge, during installation.

The bowl is typically configured for threaded engagement with the filter head.

The filter cartridge typically includes media extending between first and second end caps, the first end cap including a seal support oriented for formation of an outwardly directed seal with a portion of the filter head; and, with the second end cap having a filter support oriented for a formation of an inwardly directed seal with the bowl. In a typical such arrangement, the seal between the second end cap and the bowl is specifically a seal between the second end cap and a portion of a filter support.

A variety of features are described, which can be used independently or together, to provide advantageous arrangements.

### BRIEF DESCRIPTION OF THE DRAWINGS

FIG. 1 is schematic, top plan view of a filter assembly according to the present disclosure.

FIG. 2 is a schematic, cross-sectional view of the filter assembly in FIG. 1, taken along line 2-2, FIG. 1.

FIG. 3 is a schematic, exploded, perspective view of a filter head component of the assembly of FIGS. 1 and 2.

FIG. 4 is a schematic, cross-sectional view of a bowl component of the assembly of FIGS. 1 and 2; the view of FIG. 4 being generally along line 4-4, FIG. 5.

FIG. 5 is a top plan of the bowl component of FIG. 4.

FIG. 6 is schematic view analogous to FIG. 4, but showing the bowl with a filter support component removed therefrom.

FIG. 7 is schematic, top plan view of a filter cartridge component included in the assembly of FIG. 2.

FIG. 8 is schematic, fragmentary, side cross-sectional view showing features of an alternate filter cartridge usable in the assembly of FIG. 2.

FIG. 9 is a side elevational view of a media pack usable in the assembly of FIG. 2.

FIG. 10 is a schematic, top plan view of the media pack of FIG. 9.

### DETAILED DESCRIPTION

### I. Example Assembly

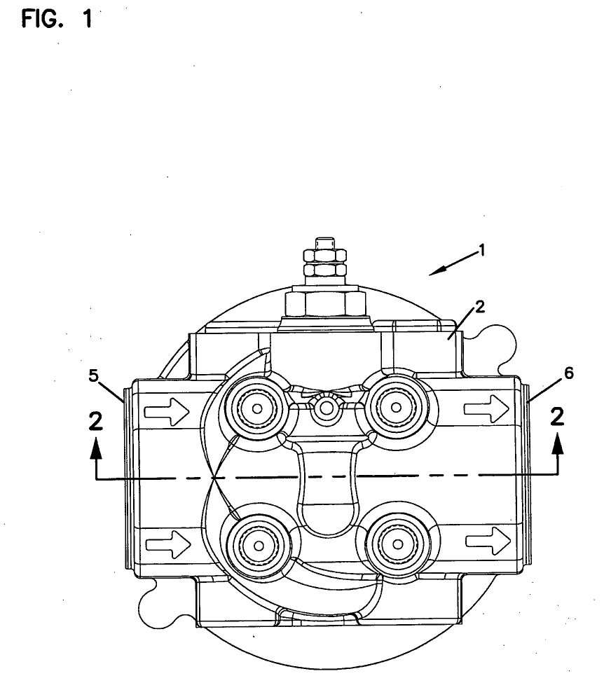

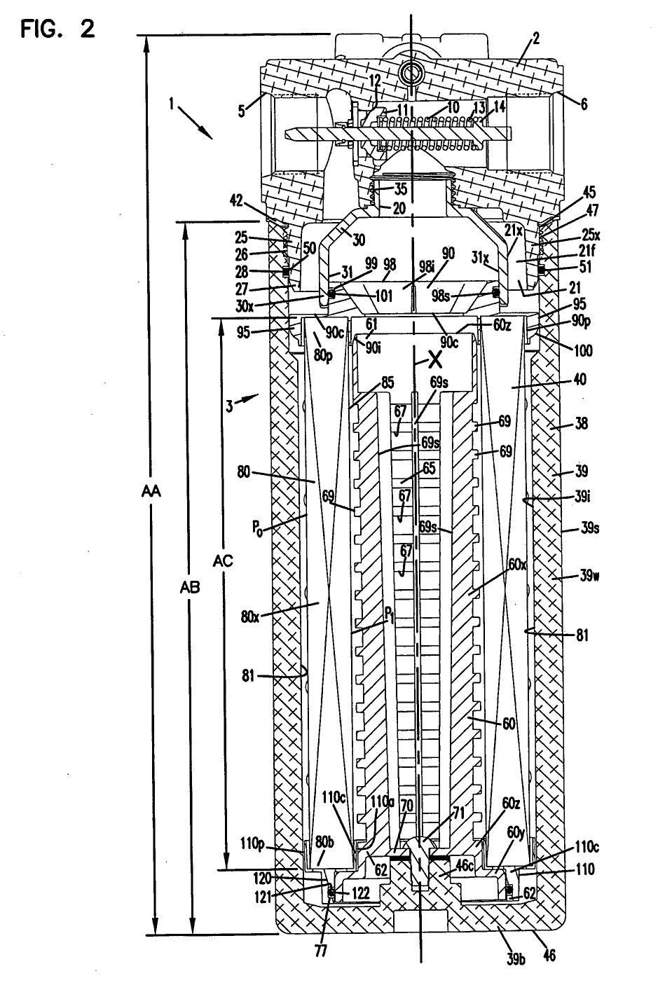

The reference numeral 1, FIG. 1, generally indicates a liquid filter assembly according to the present disclosure. The assembly 1 includes a filter head 2 to which a filter arrangement 3 (FIG. 2) according to the present disclosure is secured.

Referring to FIG. 1, generally the filter head 2 includes a liquid flow inlet arrangement 5 and a liquid flow outlet arrangement 6. During operation, liquid to be filtered enters the filter head 2 via liquid flow inlet arrangement 5. It is directed into the filter arrangement 3, FIG. 2, for filtering. Filtered liquid is then returned to filter head 2 and exits from the filter assembly 1 through liquid flow outlet arrangement 6. Filter assembly 1 can be configured for installation and use in a variety of applications including, for example, filtering hydraulic fluids or filter lubricating fluid (oil).

Attention is now directed to FIG. 2, a schematic, cross-sectional view taken along line 2-2, FIG. 1. It is noted that the filter head 2 includes a bypass valve arrangement 10. The bypass valve arrangement 10 provides for direct flow of liquid from inlet arrangement 5 to outlet arrangement 6 without passage into filter arrangement 3, should the filter arrangement 3 become sufficiently plugged during use. The bypass valve arrangement 10 generally comprises a valve member 11 closed over aperture 12, with closing valve force being provided by biasing arrangement 13, in the example shown in the form of a coiled spring 14.

Further, filter head 2 includes outer ring arrangement 25, which comprises a mounting ring for filter arrangement 3. In particular, outer ring arrangement 25 includes an outer threaded region 26 and a tip portion 27 with seal surface region 28 thereon. Threaded region 26 is configured for engagement with filter arrangement 3, during mounting. Seal surface 28 is configured for engagement with a seal member on filter arrangement 3, during installation.

In general terms, the outer ring arrangement 25 comprises an annular mounting rim 25x. The annular mounting rim 25x is, in general, configured for removable mounting thereon, of filter arrangement 3.

Still referring to FIG. 2, the filter head 2 also includes a central liquid flow arrangement 20. The central liquid flow arrangement 20 is configured for directing liquid flow from the filter arrangement 3 into the liquid flow outlet arrangement 6.

An annular liquid flow space 21 is provided between the annular mounting rim 25x and a ring portion 21x of the central flow arrangement 20. An annular flow arrangement 21f is provided by space 21 in liquid flow communication between the inlet arrangement 5 and, as will be seen below, a liquid inlet flow annulus 81 around a filter cartridge 40 retained within housing 3. In addition, ring 21x surrounds a portion of a liquid flow path from the cartridge to the liquid flow outlet 6, i.e. ring 21x surrounds a portion of the liquid flow outlet arrangement 20.

Still referring to FIG. 2, it is noted that central flow arrangement 20 comprises a portion of a seal adaptor 30 mounted on filter head 2. The seal adaptor 30 generally includes an inner ring surface 31 opposite a portion of annular flow arrangement 21f and configured for sealing engagement with filter cartridge 40, as discussed below. The adaptor 30 can be secured to the filter head by a threaded arrangement as shown at 35. The adaptor 30 can comprise either a metal or plastic construction. Adaptors analogous to adaptor 30 are described, for example, in PCT publication WO 2007/059238 A2, published May 24, 2007, the complete disclosure of which is incorporated herein by reference.

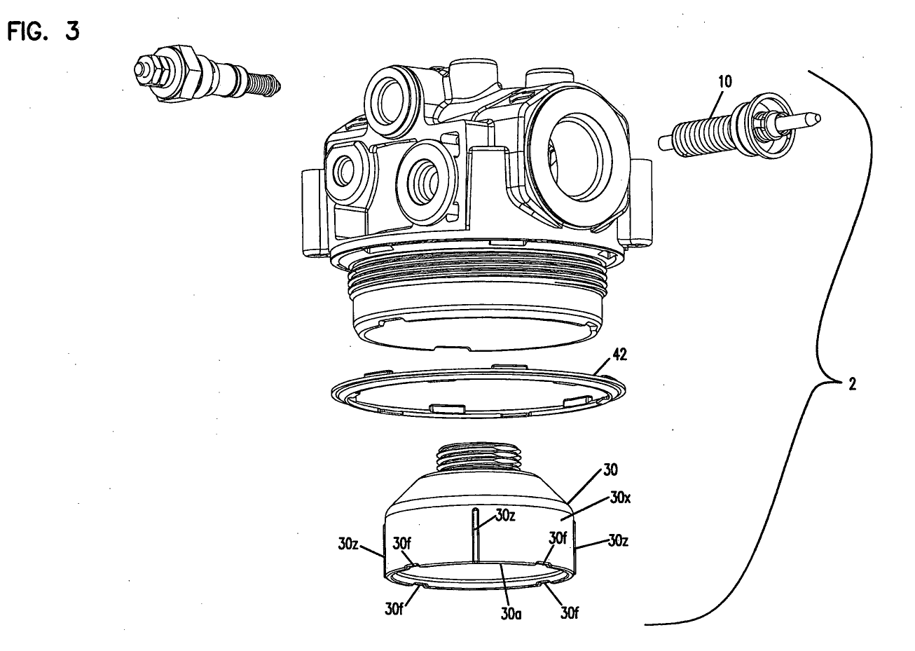

Attention is now directed to FIG. 3, in which filter head 2 is shown in schematic, exploded, perspective view. Here, adaptor 30 is shown separated from the remainder the filter head 2, and it can be seen how adaptor 30 is eventually secured in place. Attention is also directed to bypass valve 10, viewable in FIG. 3.

Referring to FIG. 2, filter arrangement 3 comprises a bowl/cartridge arrangement 38 comprising an outer housing or bowl 39 and an internally received filter cartridge 40. It is noted that the cartridge 40 is a service part, i.e. it is removable and replaceable within interior 39i of bowl 39.

Herein, filter arrangement 38 comprising a bowl 39 and a removable and replaceable, i.e. serviceable, cartridge 40, will sometimes be referred to as a bowl/cartridge arrangement 38 or alternatively as a housing/cartridge arrangement, or by similar terms. When the terms housing/cartridge and bowl/cartridge arrangement is used, the terms “housing” and “bowl” are meant to refer to the bowl 39 or similar structure, inclusive of any structure mounted thereon other than the cartridge 40. In the example shown the bowl 39 includes at least: an outer wall structure 39s; and, a seal member 51. (It also includes support 60, discussed below.)

Referring to FIG. 2, it is noted that a spacer ring 42 is positioned around filter head ring 25, between the bowl 39 and the head 2. Spacer ring 42 is also depicted in FIG. 3. Spacer ring 42 is analogous to a spacer ring described, for example, in PCT WO 2007/059238 A2, referenced above. It is also noted that no portion of the cartridge 40 is positioned (pinched) between sidewall 39s and filter head 2.

Still referring to FIG. 2, the bowl 39 includes outer wall structure 39w comprising sidewall 39s and bottom 39b, defining a first open end 45 and second closed end 46. The first open end 45 includes an internal, threaded region 47 thereat, for engagement with threaded region 26 on ring 25. Engagement between threaded region 47 and threaded region 26 allows for mounting and dismounting bowl/cartridge arrangement 38, i.e. housing or bowl 39, with respect to filter head 2.

Adjacent threaded region 47 interior 39i of housing or bowl 39 includes head seal receiver groove 50 configured for receiving head seal member 51 therein. The seal member 51 is sized and configured to engage seal surface 28 on ring 25, providing for a seal inhibiting leakage of liquid between bowl 39 and head 2 along threaded regions 47 and 26. Seal member 51 can comprise an o-ring seal, or alternately configured seals, as desired. Seal member 51 will typically comprise a circular ring.

Still referring to FIG. 2, bowl 3 includes central filter support 60. The central filter support 60 includes opposite ends 61, 62. The filter support 60 includes central open interior 65 extending along an interior thereof from end 61 downwardly. Filter support 60 is generally open or perforated, i.e. includes a plurality of openings 67 therein allowing liquid flow passage from an exterior region into interior 65. Support 60 includes a plurality of exterior hoops or ribs 69, which can provide for spaced regions of media support, during use. Interior vertical ribs 69s provide for structural support.

Central filter support 60 includes an interior flange 70 adjacent end 62. Fastener 71 engages flange 70 and secures to filter support 60 in position in central portion 46c of bowl closed end 46. Fastener 71 can comprise a bolt or screw member; however in some instances it can comprise a stud. Typically, fastener 71 will be configured so it is not to be readily removed, once assembled.

It is noted that herein, utilization of the terms “bowl” or “housing”, as explained above generally meant to refer to the combination of the filter support 60 and a remainder of the bowl 39. This is because the filter support 60 is not typically separated from the remainder of the bowl 39, during a normal servicing operation.

Still referring to FIG. 2, it is noted that end region 62 of central support 60 is non-perforated (imperforate), and has a larger outer diameter (or outer cross-sectional size) than end region 61. It is also noted that end region 61 is not perforated (imperforate).

In general terms, filter support 60 can be viewed as comprising perforate tubular extension 60x, a radial transition shoulder 60y and an end, outer, rim 62. The end, outer, rim 62 is secured in position, by the radial transition shoulder 60y to an end of the central tubular section 60x remote from end region 61, i.e. end 60z. Transition shoulder 60y is an outwardly directed imperforate ring, in a typical application.

End region or ring 62 provides an outer seal surface 77, for engagement with a seal arrangement on filter cartridge 40, during installation, as described above. On the other hand, end region 61 does not provide for sealing engagement with the cartridge 40. For reasons described below, the seal diameter for seal engagement between the cartridge 40 and a remainder of the assembly 1, will generally be larger than an internal diameter of the media in cartridge 40, and will generally smaller than an external diameter of the media 80 in the filter cartridge 40. Thus, rim 62 is generally of a larger diameter than end region 61; and, is positioned for axial overlap with media 80. By “axial overlap” in this context, it is meant that the rim 62 is positioned aligned with the media 80 at a location between inner and outer media perimeters.

Still referring to FIG. 2, attention is directed to cartridge 40. Cartridge 40, again, is a service part, i.e. it is removable and replaceable within overall assembly 1. The step of servicing involves separation of bowl 39 from head 2 and the separation of the cartridge 40 from the bowl 39.

Cartridge 40 comprises media 80 having first and second ends 80a, 80b. The media 80 comprises filter media 80x appropriate for the application intended. The media 80x can be in a variety of forms, and will typically comprise a liquid filter media such as a pleated media extending around an open central interior 85. When the media 80a comprises pleated media, outer most pleat tips Po will generally define an outer perimeter or diameter, and inner most pleat tips Pi would generally define an inner perimeter. The outer perimeter will typically be circular and the inner perimeter will be typically be circular. Often the media 80 will define a generally cylindrical perimeter configuration within the cartridge 40.

Along with central interior 85, media 80 will be in positioned adjacent, but typically spaced a small amount, from hoops or ribs 69 of support 60. Should the media 80 deflect inwardly during use, support 60, through engagement between ribs 69 and media 80 will provide interior media support. Therefor, typically the media 80 does not include a central or inner liner support as a part thereof.

The housing or bowl sidewall 39x is typically sized to provide a liquid flow annulus 81 surrounding the media 80. The annulus 81 receives unfiltered liquid from region 21, as the liquid enters bowl/cartridge filter arrangement 3 during use. The liquid is then filtered as it passes through the media 80 toward central axis X. Filtered liquid then flows into central flow arrangement 20, and then into outlet flow arrangement 6, to be directed outwardly from assembly 1.

A first end cap 90 is positioned on media end 80a with a central portion 90o extending across end 80a of media 80. Central portion 90c of the end cap 90c, closes end 80a of the media 80. The end cap 90 can be preformed, and be secured in place by an adhesive; or it can be molded directly to the media pack 80.

The end cap 90 includes an outer peripheral portion 90p surrounding the media 80 adjacent end 80a. Peripheral portion 90p includes a plurality of spaced, outwardly extending, centering projections 95 thereon. The projections 95 provide are centering projections providing for centering of cartridge 40 within bowl 39, by extending toward end portion 100 of an interior 39i of sidewall 396w, (of bowl 39).

Still referring to FIG. 2, end cap 90 also includes inner portion 90i lining an inside of media 80 adjacent end 80a. The inner portion 90i, for the example shown, is sized with an internal length sufficiently long to also extend to a location around a portion of end 61 of support 60.

End cap 90 includes central aperture 90a, in communication with open interior 85. Thus, end cap 90 is an open end cap.

End cap 90 includes a seal support member 98 thereon, projecting, generally, axially in a direction away from media 80. By the term “axial” in this context, reference is meant to a direction generally away from media 80 and opposite end cap 110 discussed below. The direction of extension is generally parallel to central axis X, but no specific requirement is meant by the term “axially” with respect to whether the projection 98 is indeed parallel to axis X, or extends at an angle relative thereto.

The seal support 98 is configured to support a seal arrangement 99 for engagement with a portion of filter head 2. For the particular example shown, support 98 includes an outer annular or peripheral groove 101 therein, i.e. therearound, for receipt of seal member 99. Seal member 99, then, surrounds support 99, and forms an outwardly directed radial seal with head 2; i.e. member 99 is a head seal member. By the term “outwardly directed” in this context, it is meant that the general direction of force for engagement between the seal member 99, and the filter head 2, is radially outward. Alternately stated, the portion of filter head 2 to which the seal member 99 is sealed, surrounds seal member 99.

For the specific example shown in FIG. 2, the seal member 99 engages an inner surface 31x of ring 31. Indeed in the example shown, seal support 98 is configured to project into a region surrounded by ring 31.

It is preferred that, for an assembly in accord with FIG. 2, sealing occur along an inside of ring 31, as opposed to an outside. A reason for this is that in inhibits the need for a cartridge component to project into region 21.

Thus, adaptor 30 can be configured to provide an outer surface 30x configured for a desirable annular flow therearound, of liquid to be filtered. For this reason, and referring to FIG. 3, outer surface 30x is typically provided with rib structure 30z inhibiting the use of surface 30x as a seal surface.

Still referring to FIG. 3, it is also noted that lower, free, edge 30e of adaptor 30 includes spaced indents 30f therein, inhibiting use of edge 30e as a seal surface.

Referring to again to FIG. 2, and the earlier discussion, in general adaptor 30 is configured to provide for a location of sealing at a desirable location, for proper operation of the assembly 1, and proper liquid flow of flow direction therein.

Still referring to FIG. 2, projection 98 is provided with an internal surface 98i, opposite the seal support groove 101, configured with supports 98s to provide strength and support of the seal arrangement 99. Also, supports 98s and projection 98 will interfere with rim 62 and shoulder 60y if an effort is made to improperly insert cartridge 40 into bowl 60.

For the particular example shown, the seal arrangement 99 is an o-ring seal, although alternatives are possible. Typically, the seal arrangement 99 will be a circular seal, usually removably mounted on projection 98.

Still referring to FIG. 2, it is noted that cartridge 40 is not sealed to end 61 of the support 60, remote from end rim 62.

A second end cap 110 is mounted on an opposite end 80b of the media 80 from end cap 90. The end cap 110 includes a central portion 110c closing end 80b of media 80, opposite end 80a. The end cap 110 further includes an outer, peripheral, rim 110p, which surrounds the media 80 adjacent end 80b. End cap 110 further includes an inner ring 110c which lines the media 80 within the open interior 85 adjacent end 80b. End cap 110 is an open end cap with a central aperture 10a in communication with open interior 85.

Projecting axially from end cap 110 in a direction opposite the media 80 is provided seal support 120. Seal support 120 includes a receiving groove 121 along an interior surface thereof, for receiving a seal member 122, for example an o-ring seal. Thus, seal support 121 is configured to support a radially inwardly directed seal member 122, for an inwardly directed radial seal. The radial seal support 120, then, is configured to extend along and surround end ring 62 of support 60, to support seal member 122 in sealing engagement with inner support 60 at support end ring or rim 62.

The seal member 122 will typically comprise a circular seal member, usually removably mounted on support 120.

From the above, it will be understood that for a typical arrangement assembly 1, a filter cartridge 40 will be provided in which a seal support on a first end cap 90 is configured to form outwardly directed radial seal on the filter head arrangement; and, a second, opposite, end cap 110 is configured to form, with a seal member 122, an inwardly directed radial seal with end seal adaptor ring or rim 62. For the example shown, the end seal ring 62 comprises a portion of an inner filter support 60.

The direction of the two seal arrangements 99, 122 in opposite seal directions, provides an advantage. Inward direction of the radial seal for end cap 120 facilitates an assembly in which a seal surface within the bowl 39s can be formed by mounting a seal adaptor in the bottom of the housing bowl, in the example shown, the adaptor being in the form of end ring 62. Thus, the housing bowl bottom 46 does not need to be machined or otherwise modified, when a metal bowl exterior is used, for a sealing surface,

On the other hand, as indicated above, an outwardly directed seal from seal 99, between the cartridge 40 and the head 2, allows for an assembly in which a support arrangement 98 for the seal 99 projects into adaptor 30, and does not surround it. This means that annular flow path 21f between the adaptor 30 and the ring 25 can be configured for an advantageous fluid flow, as no portion of a cartridge 40 is required to project upwardly therein.

In some instances a portion of a cartridge could project into this space (21f), but the design allows for an efficient operation in which a cartridge 40 is configured that has no portion projecting into this space (21f), as shown.

Typically, a seal diameter (Dₛ) for seal members 122, 99 will be the same, although alternatives are possible. Herein, the term “seal diameter” is meant to refer to the diameter of a seal between the exposed seal on the cartridge 40 and another portion of assembly 1.

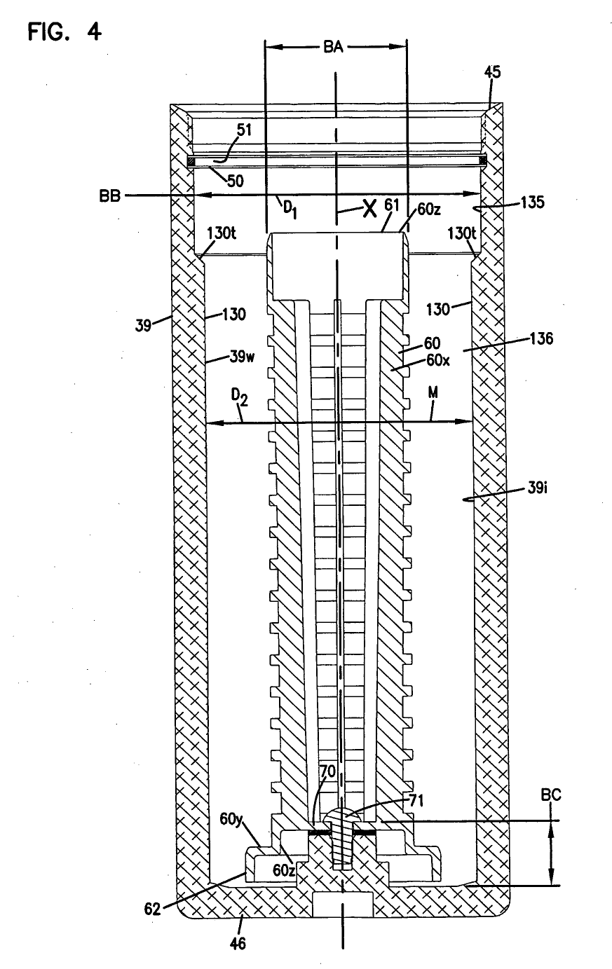

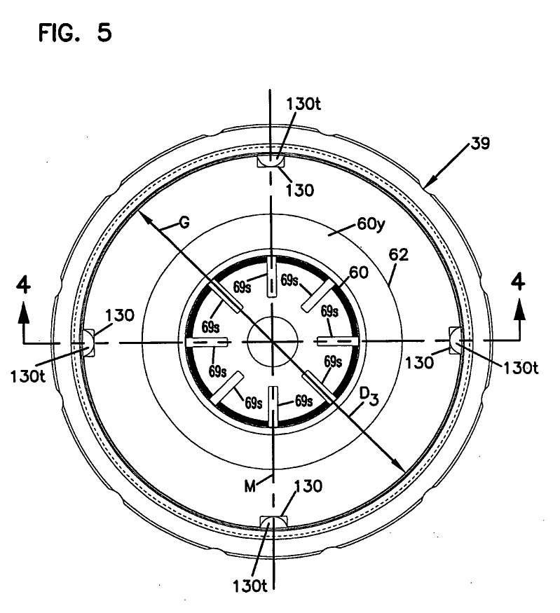

Attention is now directed to FIG. 4, in which bowl 39 is shown dismounted from the filter head 2, FIG. 2, and with cartridge 40 removed therefrom. Support 60 can be seen. Also viewable an inner surface 39i of outer wall structure 39w are ribs 130. In the example shown, the ribs 130 extend from adjacent bottom wall 46 upwardly to ends 130t. The ribs 130 terminate at ends 130t, for the example shown, adjacent region 135 along an interior of sidewall 39w, spaced from end 45 and groove 50 toward end 46. Region 135 generally has an internal cross-sectional dimension D1 larger than a cross-sectional dimension D2 (or M) between opposite ribs 130, and also larger than a cross-sectional interior dimension (D3 or G, FIG. 5) in the bowl 39 at a location between opposite portions of the sidewall between 130. Alternately stated, region 135 is recessed outwardly slightly, from a region 136 in which ribs 130 are positioned.

Attention is now directed to FIG. 5, a top plan view of the bowl 39 FIG. 4. Here, the various ribs 130 are viewable. For the particular example shown, there are four evenly spaced ribs 130, although an alternate number is possible, also usually at least 2 and typically 3-6, inclusive. Also in FIG. 5, vertical strengthening ribs 69s in support 60 are viewable.

It is noted, referring to FIG. 5, that an upper end 130 of each rib 130 is generally rounded off.

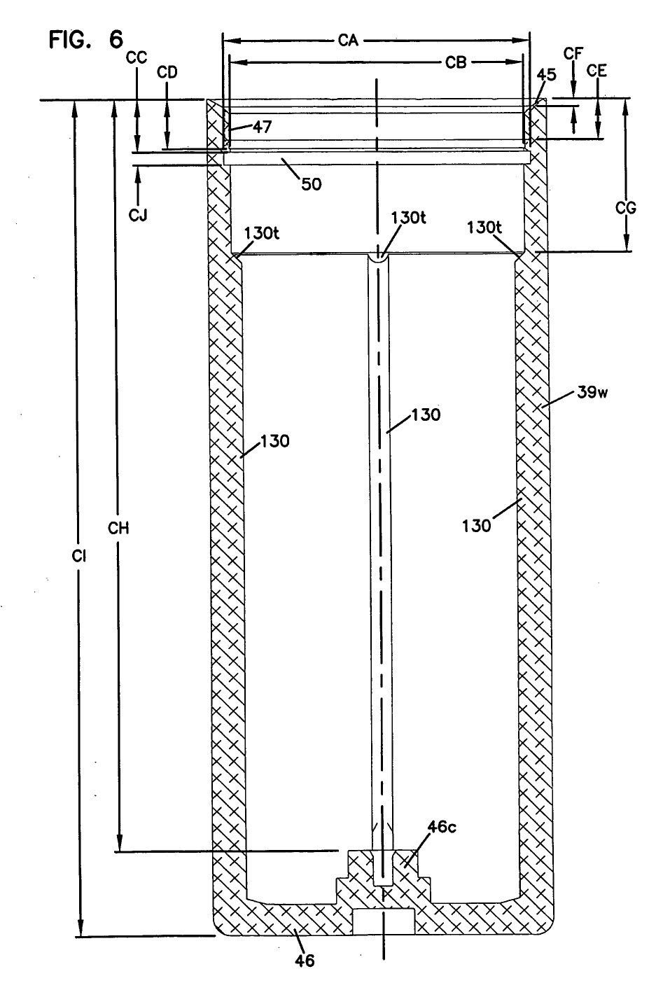

In FIG. 6, outer wall structure 39w of bowl 39 is viewable, with support 60 removed. It is noted that normally once assembled, the support 60 will not typically be removed from outer wall structure 39w.

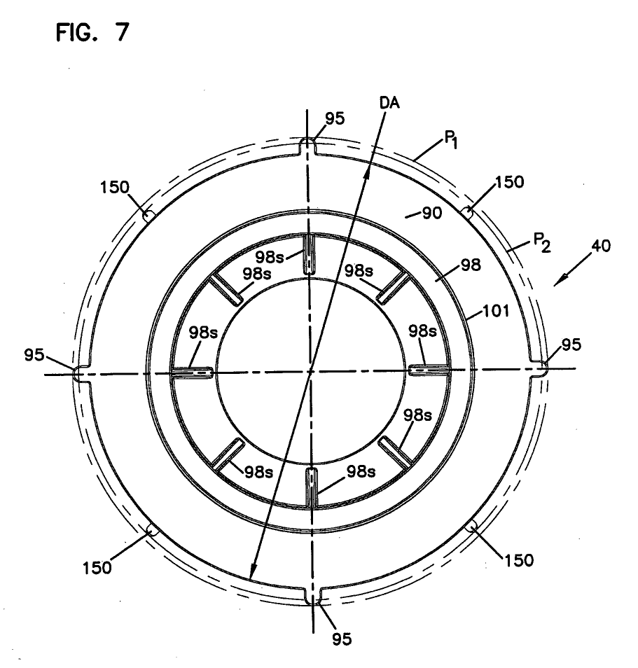

In FIG. 7, the view is of cartridge 40 directed toward upper end cap 90. The seal support 98, supported by gussets or supports 98s is viewable. Also viewable in FIG. 7, are outwardly directed centering projections 95 on end cap 90. For the example shown, there are four evenly, radially spaced, centering projections 95, although alternate numbers are possible, typically, there will be at least two such projections, and usually 3-6, inclusive, such centering projections.

Still referring to FIG. 7, projections 150 are also viewable. Projections 150, are typically mounted around an outer periphery of second end cap 110. Projections 150 are radial interference projections, and will engage ribs 130, upon relative rotation between the bowl 39 and the filter head 2. Thus, as bowl 39 is removed from the filter head, upon rotation of the bowl 39 relative to the filter head 2, radial interference projections 150 will interfere with, and engage, ribs 130. This engagement will cause the cartridge 40 to also rotate relative to the filter head 2. This will help facilitate separation of the cartridge 40 from the filter head 2, and will help keep the cartridge 40 within the bowl 39, once the bowl 39 is separated from filter head 2. This is advantageous, for a convenient servicing operation. Usually, there are at least two projections 150, typically 3-6, inclusive, four are shown.

Referring to FIG. 7, it is noted that projections 95 define an outer perimeter P1, and projections 150 define an outer perimeter P2. It is also noted that the diameter (Y) of P1 is typically larger than a diameter (X) of perimeter P2. Thus, the centering projections 95 typically project radially, outwardly further than the radial interference projections 150. The centering projections 95 are configured to center the cartridge 40, by being directed toward wall section 135. In an example in which wall section 135 is recessed slightly relative to region 136, between ribs 130, the relatively large diameter (D1) for perimeter P1 (relative to D₃ (G), FIG. 5) will also ensure that the cartridge 40 cannot be inserted wrong side down, within the bowl 39.

Typically, the projections 95 extend at least 0.4 mm further radially, outwardly, than the projections 150, usually an amount within the range of 0.5 to 1.5 mm. Thus perimeter P1 is typically has a diameter at least 0.8 mm, and usually 1-3 mm greater than a diameter of perimeter P2.

It is noted that the projection 95 generally projects at least 0.4 mm outwardly from an adjacent portion of end cap 90; and, interference projections 150 generally project at least 0.4 mm outwardly from an adjacent portion of end cap 110. Usually the amount of projection of each is at least 0.5 mm outwardly from an adjacent portions of an associated end cap.

Referring to when references meant to an amount of projection outwardly of projection 95 or projection 150, reference is meant to an amount projection outwardly relative to immediately adjacent portion of the associated end cap (90, 110).

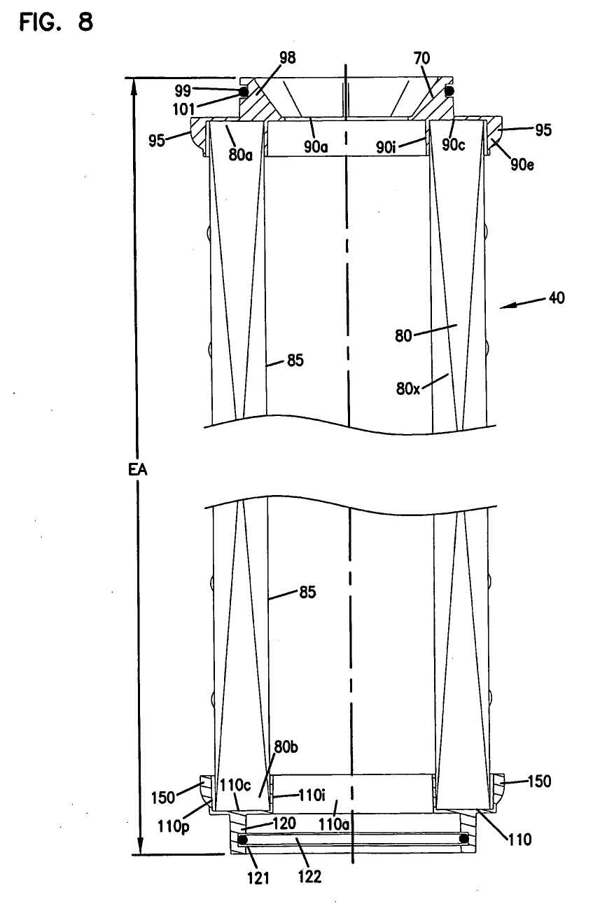

Attention is now directed to FIG. 8. FIG. 8 is fragmentary, side cross-sectional view through a cartridge 40. However, in FIG. 8 the projections on end cap 90 are radially aligned with the projections on end cap 110. This is a possible orientation, which differs from the one of FIG. 7. In FIG. 7, the projections 150 are depicted radially off-set from (i.e. between) the projections 95. There is, in the projection of FIG. 7, each projection 150 is between two projections 95, and each projections 95 is between two projections 150. Either arrangement (FIG. 5 or FIG. 8) will fit within the housing or bowl 39, and will operate.

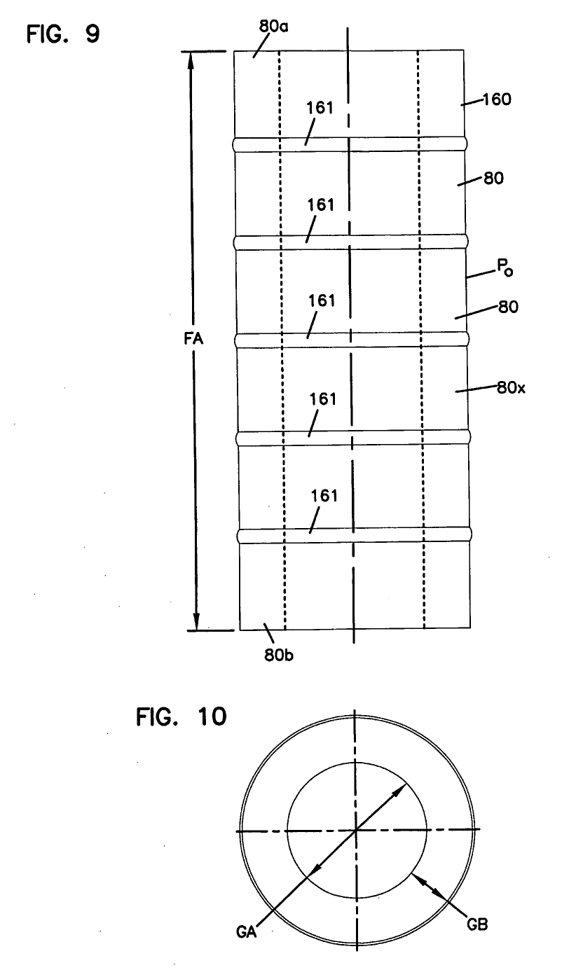

Attention is now directed to FIG. 9, in which a media pack arrangement 160 comprising media 80 is schematically depicted. The media 80 is pleated media, and is depicted schematically in FIG. 9. Around an outer portion of the outermost pleat tips Po, are provided polymeric adhesive beads 161, which secure the media 80x around an outer perimeter and provide pleat spacing.

The particular example media pack 160, and resulting cartridge 40, is devoid of an outer media support liner extending between opposite end 80a, 80b of the media 80, although alternatives are possible.

In FIG. 11, a top plan view of media pack 160.

In FIGS. 1-11, some example dimensions, for an example arrangement, are shown. The dimensions are as follows: in FIG. 2: AA=306.1 mm; AB=242.5 mm; and AC=187.8 mm; in FIG. 4, BA=41.7 mm; BB=84 mm; and BC=19.54 mm; in FIG. 6, CA=87.71 mm; CB=84 mm; CC=15.2 mm; CD=14.2 mm; CE=11.8 mm; CF=2.2 mm; CG=44.4 mm; CH=217.9 mm; CI=242.5 mm; and CJ=3.7 mm; in FIG. 7, DA=77.8 mm; in FIG. 8, EA=211.6 mm; in FIG. 9, FA=187.8 mm; and, in FIG. 10, GA=444 mm; and, GB=14.6 mm.

The particular example arrangement depicted, does not include an inner liner in the cartridge 40, comprising a portion of the cartridge 40, around which the media 80 extends. Thus, the cartridge 40 is generally inner axial load support or inner liner free. By these terms, it is meant that the typical cartridge 40 will not typically include, as an integral part therewith, an inner tubular support for substantial axial load during use. The cartridge 40 could have a pleated extension of light wire mesh or plastic mesh along an inside thereof, and could still be axial load support liner free, in accord with this definition. In general, a structure integral with a filter cartridge along an inside of the media capable of supporting an axial compressive load of at least 20 lbs (9.1 kg) is not permanently present in the filter cartridge 40, for the filter cartridge 40 to be considered “axial load coreless”, i.e. “inner axial load support or inner liner free” in accord with definition.

Also, as indicated above, the arrangement is generally outer support liner free. It is meant by the term “outer support liner free” that the cartridge 40 includes no outer liner extending along with media 80 between opposite ends 80a, 80b.

### II. Seal Location

As indicated previously, typically and preferably the seal location on the first end cap is oriented so that seal support 98 supports the seal member 99 to form an outwardly directed radial seal, with a seal diameter which is smaller than the outside diameter of the media 80, and larger than the inside diameter of the media 80. Typically, the seal location will be at least 2 mm, from the adjacent outer diameter of the media, and typically at least 3 mm, from the adjacent inner diameter of the media. Typically, the seal location will be at least 5%, usually at least 10%, across media pack end 80a, from each of the inner and outer pleat tips (media inner and outer diameter). Typically, each seal diameter will be at least 30% across the media pack from the media pack inner diameter toward the media pack outer periphery. Herein there term “adjacent” when used in this context, is meat to refer to a portion of the media 80 immediately adjacent the end cap or seal being discussed. In a cylindrical media pack, with the same outer and inner diameter along its length, there will be no difference in diameter of the media pack adjacent the end 80a, and any the other portion of the media pack, however.

In a typical arrangement, the seal will typically be supported at a location to provide a seal diameter DₛA (A representing first end cap 90) at a location no greater than 1.2 D_{b}A, typically no greater than 1.15 D_{b}A, and usually no greater than 1.1 D_{b}A, wherein D_{b}A is a balance point for net axial forces of liquid on opposite sides of end cap 90, generally in accord with the discussion of the PCT publication WO 2005/099861 A1, published Oct. 27, 2005, and incorporated herein by reference. The term “net axial force of liquid” and similar terms are exclusive of forces caused by liquid pressing directly against the media.

DₛA will usually be at least 0.8 D_{b}A, often at least 0.85 D_{b}A and typically at least 0.8 D_{b}A

Typically and preferably the seal location DₛA is within the range of 0.95-1.05 D_{b}A, although alternatives are possible.

In general terms, end cap 110 is configured for a seal support 120, to support seal member 122, to define an inwardly directed seal, with a seal diameter DₛB (B corresponding to second end cap 110) at a location with a seal diameter radially spaced inwardly from an immediately adjacent outer diameter of the media 80 at end 80b and radially spaced outwardly from an inner diameter of an immediately adjacent end 80b of the media 80. Typically, the spacing is at least 2 mm from the immediately adjacent outer diameter and least 3 mm from the immediately adjacent inner diameter. Typically the spacing is at least 5%, usually at least 10%, across the media pack end 80b from adjacent opposite inner and outer media end inner and outer perimeters. Typically, the seal diameter DₛB is at least 30% across the media pack from the media pack inner diameter toward the media pack outer periphery.

Typically and preferably seal diameter DₛB will be no greater than 1.2 D_{b}B, typically no greater than 1.15 D_{b}B, usually no more than 1.1 D_{b}B, and usually within the range of 0.95-1.05 D_{b}B; where D_{b}B is the seal diameter which creates a balance net axial fluid forces on the end cap 110 generally in accord with description of PCT publication WO 2005/099861 A1, again published Oct. 27, 2005 and incorporated herein by reference. Typically seal location DₛB is at a location of at least 0.8 D_{b}B usually at least 0.85 D_{b}B, typically at least 0.90 D_{b}B and preferably at least 0.95 D_{b}B.

### III. Some Comments and Observations

According to the present disclosure, a number of features adaptable for use in liquid filtration apparati are disclosed. Various ones of the features provided advantage. There is so no specific requirement that an arrangement include all of the features characterized herein, to obtain some advantage according to the present disclosure.

In one aspect of the present disclosure, a liquid filter cartridge for removable installation of liquid filter assembly is provided. By the term “removable” in this context, it is meant that the liquid filter cartridge is adapted to be installed within a liquid filter assembly and to be removed therefrom, without damage to the assembly. Thus, the liquid filter cartridge characterized is a service part, i.e. a part which is removed after a period of operation of a liquid filter assembly and is either replaced, or refurbished and reinstalled.

In general, the liquid filter cartridge includes filter media surrounding an open filter interior. The media has first and second ends. The filter media can be configured in the form of a cylinder, with the same inside media diameter and the same outside media diameter along the length of the cartridge. However, alternatives are possible. In many applications, the media will be pleated. When such is the case, the outermost pleat tips will define an outside circular media or pleat tip (media) diameter or perimeter (periphery); and, the most inner pleat tips, i.e. the pleat tips most remote from the outer pleat tips, will from an inner circular media or inner pleat tip (media) diameter.

The cartridge further includes first and second opposite (open) end caps. The first end cap is positioned on the first end of the media and includes a first seal support thereon. In a typical application, the first seal support projects away from the media in a direction opposite the second end cap. In addition, the second end cap is positioned on the second end of the media and includes a second seal support thereon. Typically, the second seal support projects away from the media in a direction opposite the first end cap.

The first and second end caps can be constructed from a variety of materials. In typical applications, each will comprises a molded plastic. The media end caps can be preformed and then secured to the media with an adhesive.

A typical filter cartridge includes a first seal member mounted on the first seal support. In an exampled disclosed, the first seal member is positioned surrounding the first seal support and oriented to from an outwardly directed seal. By “outwardly directed” in this context, it is meant that the seal member is oriented to form a seal between the seal support, i.e. the cartridge, and an additional structure in the liquid filter assembly, the additional structure being a structure which surrounds the first seal support, with a first seal member therebetween. In some instances, such a seal member will be referred to as an “outwardly directed radial seal member”, or by similar terms.

The seal diameter for the first seal member will refer to herein by the term DₛA. In this context, the letter “D” refers to diameter, while the letter “S” refers to the seal, and the letter “A” refers to the first seal member, first seal support and first end cap.

In a typical application DₛA is less than the adjacent outside perimeter diameter of the media. By the term “adjacent” in this context, it is meant that the seal diameter of the first seal member is of a size smaller than a media outer perimeter diameter of the media at the first end, i.e. the end closest to adjacent of the first seal support. Typically, the DₛA has a seal diameter is greater than an adjacent inner diameter of the media. Again, the inner diameter of the media is the diameter of the open space immediately surrounded by the media (i.e. inner most pleat tips when the media is pleated). The term “adjacent” in this context, again, refers to the end of the media, i.e. the first end, most adjacent to the first seal member and first seal support.

In a typical arrangement according to the present disclosure, a second seal member is mounted on the second seal support and oriented to form an inwardly directed seal diameter DₛB. Here the term “B” is meant to refer to second seal member, second seal support and second end cap.

With a typical arrangement DₛB is less than an adjacent outer perimeter diameter of the media; and, DₛB is greater than an adjacent inner diameter of the media. Here the term “adjacent” of course refers to the second end of the media, i.e. the end of the media closest to the second end cap, second seal support and second seal member.

Typically, the second seal member is oriented to form an inwardly directed radial seal.

In a typical liquid filter cartridge as depicted herein, the first end cap includes an outer periphery with a plurality of spaced, radially, outwardly projecting, centering projections thereon. The term “centering projection” in this context, is meant to refer to a projection on the first end cap that projects radially outwardly, i.e. away from a central axis extending through the first end cap and filter cartridge. The centering projections will operate to help center the first end of the cartridge within a housing or bowl, in which the liquid filter cartridge is installed for use. Also, the centering projections can be used to ensure that the cartridge is not inserted upside down into the bowl.

In the typical assembly, there are at least two centering projections and usually 3-6 centering projections, although alternative are possible.

In the example described herein, each centering projection on the first end cap projects radially outwardly at least 0.4 mm from an immediately adjacent portion of the end cap. Typically the amount of projection as characterized, is at least 0.5 mm and usually, more than 1 mm.

Also in an example described herein, the second end cap includes an outer periphery with a plurality of outwardly projecting, spaced, interference projections thereon. In this context, the term “outwardly projecting” refers to a projection which is away from the second end cap in a direction away from a central axis through the filter cartridge and second end cap. Typically there are at least two, spaced, radial interference projections and usually 3-6, inclusive.

The radial interference projections are sized and shaped to rotationally interfere with the structure within a housing or bowl in which the filter cartridge is installed for use. This will cause the cartridge to rotate relative to the filter head, when the housing or bowl is rotated, facilitating dismounting of the cartridge from a filter head in use.

Typically, the number of centering projections is the same as the number of radial interference projections. Typically, the centering projections are evenly radially spaced around the first end cap; and, the radial interference projections are radially evenly spaced around the second end cap. Typically, each radial interference projection projects radially, outwardly at least 0.4 mm from immediately adjacent portions of the second end cap, usually at least 0.5 mm and often more than 1 mm.

In one example embodiment, in end projection, the centering projections and interference projections are positioned such that, in a projection view, a centering projection is positioned between two adjacent radially interference projections; and, a radial interference projection is positioned between two adjacent centering projections. In an alternate example embodiment, the centering projections and interference projections are radially aligned.

Typically, each centering projection projects radially, outwardly from the media a greater than the each interference projection. Typically the greater distance of projection of each centering projection relative to each interference projections is at least 0.4 mm, usually at least 0.5 mm. Alternately phrased, in a typical example of centering projections define an outer periphery Y, the radial interference projections define an outer periphery X, with Y greater than X; typically Y is being at least 0.8 mm (usually at least 1 mm) greater than Y.

A typical liquid filter cartridge according to the present disclosure is axial load inner liner free. This is sometimes characterized herein as the liquid filter cartridge having an axial load inner liner free construction. By these and similar terms, it is meant that the filter cartridge does not include an inner liner around which the media is positioned, which is configured to support a substantial axial load (as previously defined) on the cartridge.

Also, typically a liquid filter cartridge according to the present disclosure is outer liner free. By this, it is meant there is no outer liner around the media extending between opposite ends of the media.

In a typical arrangement according to the present disclosure, the seal diameter of the first seal (DₛA) is no greater than 1.2 D_{b}A, where D_{b}A is a diameter at which no net axial liquid force on the first end cap occurs. For given liquid filter cartridge, D_{b}A and D_{b}B can be measured in accord with techniques described in published PCT applications WO 2005/099861, published Oct. 27, 2005 and incorporated herein by reference.

Typically, DₛA is at least 0.8 D_{b}A. In a typical application, DₛB is also at least 0.8 D_{b}B.

In a typical arrangement DₛA is equal to DₛB.

Advantageous arrangements result when DₛA is within the range of 0.85-1.15 D_{b}A, more preferably 0.9-1.1 D_{b}A, most preferably 0.95-1.05 D_{b}A. Also advantageous arrangements result when DₛB is within the range of 0.85-1.15 D_{b}B inclusive, or preferably 0.9-1.1 D_{b}B inclusive, most preferably 0.95-1.05 D_{b}B inclusive. Advantageous seal diameters or the type characterized, provide for advantageous reduced (relative to seals on inner diameter or outer diameter end caps) liquid pressure stress on the cartridge. That is, the filter cartridge is configured and sealed within the liquid filter assembly in a manner providing for lower axial stress due to liquid filter pressure on the end caps.

The centering projections on the first end cap facilitate installation and centering within a housing, during use. The radial interference projections on the second end cap provide for a radial interference fit of the cartridge in a housing during use, so that when a housing or bowl is rotated, the cartridge rotates with the bowl. This facilitates disconnection of the cartridge from the filter head.

Having the centering projections define a larger radial perimeter than the interference projections, can be use to provide several desirable effects: first, the liquid filter system, (within which the cartridge is to be installed) can be configured so the cartridge can only be installed with a proper orientation, i.e. with a second end cap pushed into the bowl or housing first. Further, the use of larger centering projections can allow for a system in which a bowl our housing is made, which has an open end with a larger inside diameter, than an approximate inside diameter at a lower, closed, end.

Direction of the lower radial seal inwardly, facilitates installation in a housing bowl, with a central core installed therein which is not removed during servicing. Projection of the first end cap outwardly provides for several advantageous effects: first, it facilitates an arrangement in which the cartridge can only be installed in a housing or bowl when oriented in the proper orientation, i.e. with the second end cap pushed into the bowl or housing first. Also, the outwardly directed seal facilitates an arrangement in which a desirable inlet flow space is achieved.

Herein, a liquid filter arrangement is described which comprises a housing or bowl having a open end and a closed end, the bowl including a filter support therein secured to the closed end of the bowl. The filter support has a first end and a second end. The filter support second end has a larger outer cross-sectional size than the first end.

A cartridge including some or all of the features as previously described is installed in the bowl with: the seal arrangement of the second end cap secured to the second end of the filter support; and, the seal member of the first end cap outwardly directed and not sealed to the first end of the filter support.

In such arrangements, the filter media will be configured to extend around a portion of the filter support. That is, a portion of the filter support projects into the open filter interior, i.e. the space surrounded by the media. The filter support secured within the housing can be sized to operate as an inner filter support for the media, against cartridge deformation inwardly under liquid pressure. This is advantageous when the filter cartridge is axial load inner liner free.

Typically, the portion of the filter support surrounded by the media, extends from a second end of the media toward the first end of media, and terminates no lower than a location surrounded by a portion of the first end cap. By “surrounded by” in this context, it is meant that the end of the filter support characterized, is at a vertical location at least as high equal to a portion of the first end cap. This feature helps ensure that along its length, the media is protected against inner deformation due to liquid pressure, by the inner filter support.

In an example liquid filter arrangement according to the present disclosure, the bowl includes a bowl inner wall extending between a bowl open end and a bowl closed end. The bowl inner wall includes a plurality of spaced ribs thereon. Typically there at least two such ribs, and usually 3-6 such ribs, although alternatives are possible. The plurality of ribs extend in a direction generally between the open and closed ends. Typically, the ribs are positioned to extend from a location at or adjacent the closed end, toward the open end, but terminating short of the open end.

The ribs are configured for radial interference with the interference projections on the second end cap, when present. That is, as the bowl is rotated during a rotation, the rib on the bowl interior will engage the interference projection on the second end cap and when this occurs, the cartridge will begin to rotate with the bowl.

Typically the ribs extends at least 50% of the length of the inner wall between the closed end and open end, and usually at least 60% of this distance.

Typically, the bowl inner surface includes a non-ribbed region extending between the ribs and the open end of the bowl, and the ribs are each of the same length. The non-ribbed region typically includes a threaded region therein, for mounting and dismounting on a filter head. The threaded region is typically adjacent the open of the bowl.

The bowl inner surface also typically includes a non-ribbed, non-threaded, region between the threaded region and the ends of the ribs. Within this region are typically provided: a filter head seal groove, for receiving a seal member; and, a non-ribbed, non-grooved, non-threaded region between the groove and the ends (tips) of the ribs. This latter region (non-threaded, non-ribbed, and non-grooved) typically has a diameter sized to circumscribe the centering projections on the first end cap. In some arrangements, this region will have an inside diameter (D1) that is larger than an inside diameter G of the inner wall (discounting the ribs) where the ribs are located.

The housing ribs can be said to define an inner periphery of cross-section M, where the centering projections define a diameter X greater dimension M, and where the interference projections define an outer perimeter Y which is also greater than M. Also, Y is typically greater than G.

Typically, the filter support within the bowl comprises: a tubular extension surrounded by the media; and, an end rim or ring not surrounded by the media, but overlapped axially by the second end of the media during installation and having a larger cross-sectional size than the open filter interior. A radial transition shoulder is provided extending between the tubular extension and the end rib. Typically, the radial transition shoulder and the end rim are each imperforate.

In some instances the bowl or housing is metal and the filter support is plastic, although alternatives are possible. A fastener such a screw, bolt or stud can be used to secure the filter support within the bowl. Typically, the securement is conducted so that the support remains with the bowl, during a service operation in which the filter cartridge is removed and replaced within the bowl.

Also according to the present disclosure a liquid filter assembly as provided. The liquid filter assembly includes a liquid filter head, a bowl and a serviceable filter cartridge. The bowl and serviceable filter cartridge can include some features as previously described.

The liquid filter head generally includes a liquid inlet flow arrangement, a liquid outlet flow arrangement, an outer mounting rim, an inner sealing rim, a annular flow arrangement and a central flow arrangement. The annular flow arrangement provides for liquid flow path from the inner flow arrangement into an annular region between the outer mounting rim and the inner sealing rim. Preferably the annular region between the outer mounting and inner sealing rim is configured such that no portion of the cartridge projects therein, during installation.

The central flow arrangement provides a liquid flow path from a region surrounded by the sealing rim to the outlet flow arrangement. Preferably, the surface of the sealing rim directed inwardly, i.e. positioned in the central flow arrangement, is configured to receive a seal arrangement on a first end cap of a filter cartridge, sealed thereto.

The outer mounting rim typically includes an outer threaded section and outer seal surface portion. The outer threaded section is located between the outer seal surface portion and the liquid inlet flow arrangement. The outer seal surface portion provides for engagement with a seal mounted in the housing bowl, for sealing during installation and assembly.

Typical arrangements according to the present disclosure are configured such that no portion of each cartridge end cap or seal thereon is pinched between the outer wall of the bowl and the mounting ring of the filter head.

An arrangement is described in which the central flow arrangement is defined, at least in part, by a seal adaptor threadably installed in a remainder of a liquid filter head. The seal adaptor can be threadably installed with a sealant or adhesive, to inhibit removal.

There is no requirement that an arrangement include all of the sections described herein to obtain some benefit according to the present disclosure.

As indicated previously, the principles can be applied to provide a variety of useful liquid filter arrangements in various equipment. Such liquid filter arrangements would include, for example, hydraulic fluid filter arrangements and/or lubricating fluid (oil) filter arrangements. Various selected ones to the principles described can be applied in the system, for advantageous effects.

What is claimed is:

1. A liquid filter cartridge for removable installation in a liquid filter assembly, the filter cartridge comprising:
(a) filter media surrounding an open filter interior; the media having first and second opposite ends;
(b) first and second, opposite, open end caps;
(i) the first end cap being positioned on the first end of the media and including a first seal support thereon; the first seal support projecting away from the media in a direction opposite the second end cap; and,
(ii) the second end cap being positioned on the second end of the media and including a second seal support thereon; the second seal support projecting away from the media in a direction opposite the first end cap;
(c) a first seal member mounted on and surrounding the first seal support and oriented to form an outwardly directed seal of a diameter DₛA wherein:
(i) DₛA is less than an adjacent outer diameter of the media; and,
(ii) DₛA is greater than an adjacent inner diameter of the media; and,
(d) a second seal member mounted on the second seal support and oriented to form an inwardly directed seal of a diameter DₛB wherein:
(i) DₛB is less than an adjacent outer diameter of the media; and,
(ii) DₛB is greater than an adjacent inner diameter of the media.

2. A liquid filter cartridge according to claim 1 wherein:
(a) the first end cap includes an outer periphery with a plurality of spaced, radially outwardly projecting, centering projections thereon.

3. A liquid filter cartridge according to claim 2 wherein:
(a) each centering projection on the first end cap projects radially outwardly at least 0.4 mm from a immediately adjacent portion of the first end cap.

4. A liquid filter cartridge according to claim 1 wherein:
(a) the second end cap includes an outer periphery with a plurality of spaced, radially, outwardly, projecting radial interference projections thereon.

5. A liquid filter cartridge according to claim 4 wherein:
(a) each radial interference projection projects radially outwardly at least 0.4 mm from immediately adjacent portions of the second end cap.

6. A liquid filter cartridge according to claim 5 wherein:
(a) the first end cap includes an outer periphery with a plurality of spaced, radially outwardly projecting, centering projections thereon; and,
(b) each centering projection extends radially outwardly from the media a greater distance than each interference projection.

7. A liquid filter cartridge according to any one of claim 1 wherein:
(a) DₛA is no greater than 1.2 D_{b}A;
(b) DₛB is no greater than 1.2 D_{b}B;
(c) DₛA is at least 0.8 D_{b}A; and,
(d) DₛB is at least 0.8 D_{b}B;
(e) wherein D_{b}A is a diameter at which no net axial liquid force on the first end cap occurs; and D_{b}B is a diameter at which no net axial liquid force on the second end cap occurs.

8. A liquid filter arrangement comprising:
(a) a bowl having an open end and a closed end;
(i) the bowl including a filter support therein secured to the closed end of the bowl;
(A) the filter support having a first end and a second end;
(B) the filter support second end having a larger outer cross-sectional size than the first end;
(b) a liquid filter cartridge removably installed in the bowl; the liquid filter cartridge comprising:
(i) filter media surrounding an open filter interior and having first and second opposite ends;
(A) the filter media being positioned with the first end of the filter support projecting into the open filter interior; and,
(ii) first and second, opposite, open end caps;
(A) the first end cap being positioned on the first end of the media and including a first seal support projecting away from the media in a direction opposite the second end cap; and.
(B) the second end cap being positioned on the second end of the media pack and including a second seal support projecting away from the media pack in a direction opposite the first end cap;
(iii) a first seal member mounted on the first seal support and oriented to form an outwardly directed seal; and,
(iv) a second seal member mounted on the second seal support; the second seal member forming an internally directed seal with the second end of the seal support, the seal being at a diameter DₛB wherein DₛB is greater than an adjacent inner diameter of the media.

9. A liquid filter arrangement according to claim 8 wherein:
(a) the bowl includes a bowl inner wall extending between the closed end and the open end;
(i) the bowl inner wall including a plurality of spaced housing ribs extending from adjacent an inside closed end of the bowl toward the open end of the bowl; and,
(b) the second end cap includes an outer periphery with a plurality of spaced, radially outwardly projecting interference projections thereon that extend radially sufficiently to interfere with the spaced housing ribs upon relative rotation between the bowl and the cartridge.

10. A liquid filter arrangement according to claim 9 wherein:
(a) the housing ribs do not extend all the way to the open end of the bowl;
(i) the bowl inner surface having a non-ribbed region extending between the ribs and the open end; and,
(b) the first end cap includes an outer periphery with a plurality of spaced centering projections extending radially outwardly therefrom;
(i) the centering projections extending radially toward the non-ribbed region of the bowl inner surface.

11. A liquid filter arrangement according to claim 10 wherein:
(a) the interference projections define an outer perimeter diameter X; and,
(b) the centering projections define an outer perimeter diameter Y;
(i) Y being greater than X.

12. A liquid filter arrangement according to claim 11 wherein:
(a) the housing ribs define an inner periphery of cross-sectional dimension M; and,
(b) the centering projections define an outer perimeter of diameter Y;
(i) Y being greater than M.

13. A liquid filter arrangement according to claim 12 wherein:
(a) the filter support comprises a perforate tubular extension surrounded by the media; an end rim not surrounded by the media, overlapped axially by the second end of the media and having a larger cross-sectional size than the open filter interior; and, a radial transition shoulder extending between the tubular extension and the end rim.

14. A liquid filter arrangement comprising:
(a) a bowl having an open end and a closed end;
(b) a filter support therein secured to the closed end of the bowl;
(i) the filter support including: a perforate tubular extension; a radial transition shoulder; and, an end rim;
(ii) the end rim having a larger outer cross-sectional size than the perforate tubular extension; and,
(iii) the radial transition shoulder extending between the perforate tubular extension and the end rim; and,
(c) a liquid filter cartridge: installed in, and selectively removable from, the bowl; and, separable form the filter support, the liquid filter cartridge comprising:
(i) filter media surrounding an open filter interior and having first and second, opposite, ends;
(ii) first and second opposite, end caps; each having a central aperture therethrough;
(A) first end cap being positioned on the first end of the filter media and including a first seal arrangement thereon,
(B) the second end cap being positioned on the second end of the media and including a second seal arrangement thereon;
(iii) the liquid filter cartridge being positioned in the bowl with:
(A) the second seal arrangement removably sealed to the end rim of the filter support;
(B) the end rim of the filter support being in axial overlap with the second end of the media;
(C) the perforate tubular extension projecting into the open filter interior; and,
(D) the first end cap and the first seal arrangement surrounding and not sealed, to the filter support.

15. A liquid filter arrangement according to claim 14 wherein:
(a) the bowl includes a bowl inner wall extending between the closed end and the open end;
(i) the bowl inner wall including a plurality of spaced housing ribs extending from adjacent an inside closed end of the bowl toward the open end of the bowl; and,
(b) the second end cap includes an outer periphery with a plurality of spaced, radially outwardly projecting, interfering projections thereon that extend radially sufficiently to interfere with the spaced housing ribs upon relative rotation between the bowl and the cartridge.

16. A liquid filter arrangement according to claim 15 wherein:
(a) the housing ribs do not extend all the way to the open end of the bowl;
(i) the bowl inner surface having a non-ribbed region extending between the ribs and the open end; and,
(b) the first end cap includes an outer periphery with a plurality of spaced centering projections extending radially outwardly therefrom;
(i) the centering projections extending radially toward the non-ribbed region of the bowl inner surface.

17. A liquid filter arrangement according to claim 16 wherein:
(a) the interfering projections define an outer perimeter diameter X; and,
(b) the centering projections define an outer perimeter diameter Y;
(i) Y being greater than X.

18. A liquid filter arrangement according to claim 17 wherein:
(a) the filter support includes a first remote end from the transition shoulder and end rim; and,
(b) the first remote end is surrounded by the first end cap.

19. A liquid filter arrangement according to claim 18 wherein:
(a) the bowl includes an internally threaded section adjacent the open end;
(b) the bowl includes a head seal receiving groove between the threaded section and the closed end; and,
(c) the liquid filter arrangement includes a head seal member positioned in the head seal receiving groove.

20. A liquid filter arrangement according to claim 19 wherein:
(a) the bowl includes an inner wall extending between the closed end and the open end;
(i) the bowl inner wall including a plurality of spaced housing ribs extending from adjacent on inside closed end of the bowl toward the open end of the bowl;
(A) each one of the plurality of spaced housing ribs terminating at a location spaced a distance from the open end of the bowl; and,
(B) the plurality of ribs defining an rib inner perimeter of diameter M; and,
(b) the filter cartridge first end cap includes a plurality of spaced radially outwardly projecting centering projections thereon; the centering projections defining a perimeter of diameter Y;
(i) Y being greater than M.

21. A liquid filter arrangement according to claim 20 wherein:
(a) the second end cap includes a plurality of spaced, radially outwardly projecting radial interference projections thereon; defining a perimeter of diameter X;
(i) X being greater than M.

22. A liquid filter arrangement according to claim 21 wherein:
(a) Y is greater than X.

23. A liquid filter arrangement according to claim 22 wherein:
(a) the bowl inner sidewall defines a first outwardly recessed region adjacent the open end and a second ribbed region adjacent the closed end; and,
(b) the first end cap is sized to project into the first outwardly recessed region; and,
(c) the first end cap is sized too large to be inserted into the second ribbed, region.
